(19) United States
(12) Patent Application Publication
(10) Pub. No.: US 2006/0245129 A1
(43) Pub. Date: Nov. 2, 2006

(54) Latching solid state relay

(76) Inventor: Peter Kevin Bamburak, McKinney, TX (US)

Correspondence Address: PETER F WEINBERG;GIBSON DUNN AND CRUTCHER LLP, SUITE 4100, 1801 CALIFORNIA STREET, DENVER, CO, 80202, US

(21) Appl. No.: 11/120,084

(22) Filed: May 2, 2005

(51) Int. Cl. H02H 3/00

(52) U.S. Cl. 361/62

(57) ABSTRACT

A latching relay coupled SSR circuit provides a simple means of achieving a true latching solid-state relay in both two or three input terminal configurations, with two output terminals switched by standard solid-state relay devices. The circuit does not require any additional power sources, and has true indefinite memory retention of the last state the output was in when all power is disconnected. The latching relay coupled SSR circuit can be configured for a “zero-cross” mode of turn-on style to synchronize with the AC waveform powering the load that cannot be done with electromechanical latching relays, in addition to the purely “random” style of load switching. A latching relay is utilized. The isolation of the input side to the output side is provided by the physical separation of the coil and switch, utilizing the magnetic field of the coil to actuate the switch.

### FIELD OF THE INVENTION

This invention relates to latching (bi-stable) relay applications, and more particularly, to a latching solid-state relay (“SSR”).

### BACKGROUND OF THE INVENTION

Latching (bi-stable) electromechanical relays are an important segment of the overall relay market, providing contact functions that change state with a brief voltage pulse on the coil (input), and maintain that state without further energizing the input. These mechanical relays typically have either two or three terminal inputs and two output (switched) connections per pole. When using the two terminal input method, the polarity of the input signal that is momentarily applied determines the output state. When using the three terminal input method, a pulse on one terminal will “set” (close) the output of the relay, while applying a pulse to another terminal will “reset” (open) the output. The third input terminal is used as a common to both the “set” and “reset” inputs. True latching relays also maintain the output contact state independent of the presence or absence of load power.

Designers that want to use an SSR in latching applications are limited in their choices. Since the typical SSR uses power from the input connections to pass a signal (typically light) across an isolation barrier to turn on the output circuitry of the SSR, once power is removed from the input, the state of the output reverts to its “normal” un-powered condition. Various solutions have been utilized in attempts to provide a latching SSR but all involve additional connections to the relay beyond the traditional two terminal input (or three terminal input) isolated from the two terminal output. Examples of these solutions include either additional power supplies or additional connections to a “constantly powered” line circuit to maintain power to the additional logic circuitry, or solutions which incorporate “un-isolated” input to output circuitry, so that the last latched state of the output will not be lost when power is removed from the output side of the relay.

### BRIEF DESCRIPTION OF THE DRAWINGS

FIG. 1 shows a schematic diagram of a typical photo-transistor coupled non-latching SSR circuit.

FIG. 2 shows a schematic diagram of a typical opto-triac-driver non-latching SSR circuit.

FIG. 3 shows a schematic diagram of a latching relay coupled SSR circuit with a three terminal input in an embodiment of the present invention.

FIG. 4A shows a schematic diagram of a latching relay coupled SSR circuit with a two terminal input in an embodiment of the present invention.

FIG. 4B shows an alternate two terminal input circuit for the latching relay coupled SSR circuit of FIG. 4A in an embodiment of the present invention.

FIG. 5 shows a schematic diagram of a latching relay coupled triac driver circuit with a three terminal input in an embodiment of the present invention.

FIG. 6 shows a block diagram of a latching relay coupled direct current (“DC”) SSR circuit with a three terminal input in an embodiment of the present invention.

### DETAILED DESCRIPTION OF THE INVENTION

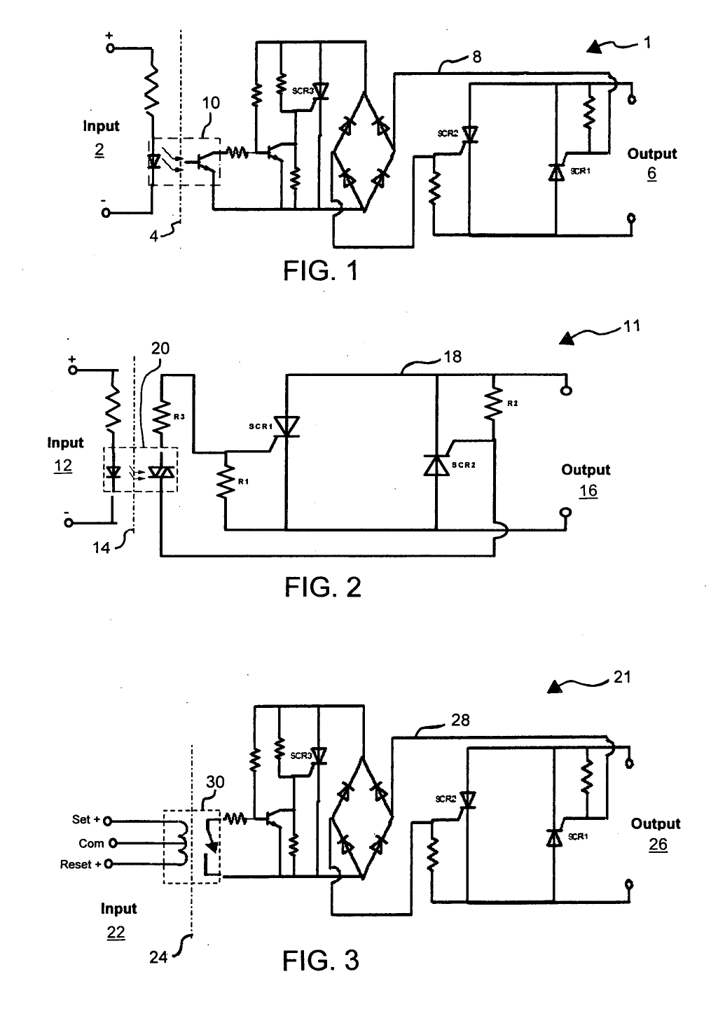

Referring now to the Figures, in which like reference numerals and names refer to structurally and/or functionally similar elements thereof, FIG. 1 shows a schematic diagram of a typical phototransistor coupled non-latching SSR circuit. Referring now to FIG. 1, Dashed Line 4 marks the isolation between the Input 2 side and the Output 6 side of Phototransistor Coupled SSR Circuit 1. Phototransistor 10 couples the signal from the Input 2 side to the SSR 8 circuit on the Output 6 side. Phototransistor 10 is non-latching. Phototransistor Coupled SSR Circuit 1 can be configured for either “zero-cross” or “random” turn-on style.

FIG. 2 shows a schematic diagram of a typical opto-triac-driver non-latching SSR circuit. Referring now to FIG. 2, Dashed Line 14 marks the isolation between the Input 12 side and the Output 16 side of Opto-Triac-Driver SSR Circuit 11. Opto-Triac-Driver 20 couples the signal from the Input 12 side to the SSR 18 circuit on the Output 16 side. Opto-Triac-Driver 20 is also non-latching. Opto-Triac-Driver SSR Circuit 11 can be configured for either “zero-cross” or “random” turn-on style depending upon the opto-coupler used.

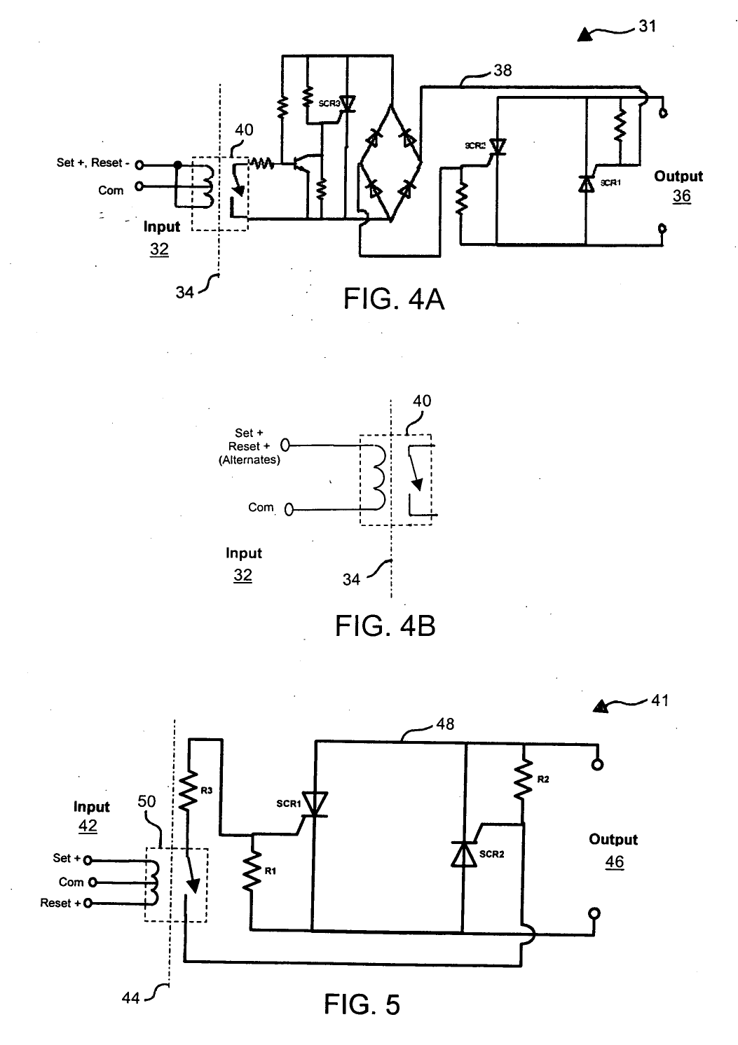

FIG. 3 shows a schematic diagram of a latching relay coupled SSR circuit with a three terminal input in an embodiment of the present invention. Referring now to FIG. 3, Latching Relay Coupled SSR Circuit 21 provides a simple means of achieving a true latching solid-state relay that can be available in both two (see FIG. 4) or three input terminal configurations, with two output terminals switched by standard solid-state relay devices. Latching Relay Coupled SSR Circuit 21 does not require any additional power sources, and has true indefinite memory retention of the last state the output was in when all power is disconnected. Current literature from various manufacturers state that latching SSRs are not possible, and that electromechanical relays must be used as one cannot use solid state relays. For example, in the “Solid State Relay Users Guide” Cat. No. Y108-E1-1 ©2001 by OMRON Electronics LLC, page 16, under the topic of Designing SSR Circuits, Section (4), Self-Holding Circuits, the statement is made that “Self-holding circuits must use mechanical relays. SSRs cannot be used to design self-holding circuits.” Similarly, in “Solid State Relays” Publication 700-AT001A-EN-E June 2002 by Allen-Bradley, page 2-7, under the topic of Considerations When Designing SSR Control Systems, Self-Holding (Latching) Circuits, the statement is made that “Self-holding or latching circuits must use mechanical relays. SSRs cannot be used to design self-holding circuits.” The present invention shows that these statements are no longer true.

Dashed Line 24 marks the isolation between the Input 22 side and the Output 26 side of Latching Relay Coupled SSR Circuit 21. Latching Relay 30 couples the signal from the Input 22 side to the SSR 28 circuit on the Output 26 side. Latching Relay 30 may be any magnetically operated latching relay that has adequate specifications to provide the desired input and isolation characteristics, along with sufficient mechanical switch ratings to actuate the SSR 28 circuit portion of Latching Relay Coupled SSR Circuit 21. Latching Relay Coupled SSR Circuit 21 can be configured for a “zero-cross” mode of turn-on style to synchronize with the AC waveform powering the load that cannot be done with electromechanical latching relays, in addition to the purely “random” style of load switching.

The input signal on the Input 22 side is typically a low voltage and current. Output 26 side switches the AC line voltage and load. Latching Relay Coupled SSR Circuit 21 is identical to Phototransistor Coupled SSR Circuit 1 except it substitutes Latching Relay 30, which may be any suitable magnetically operated latching relay as described immediately above, in place of Phototransistor 10 as shown in FIG. 1. The coil of Latching Relay 30 is the input circuit, with its coil connection wires attached directly to the input terminals of Latching Relay Coupled SSR Circuit 21. The switch of Latching Relay 30, which may be a reed type switch or simply contacts, is connected to Output 26 side of Latching Relay Coupled SSR Circuit 21, and performs the same function as Phototransistor 10 within Phototransistor Coupled SSR Circuit 1, which is to trigger or switch the solid-state circuitry that carries the ultimate load. The isolation of Input 22 side to Output 26 side is provided by the physical separation of the coil and switch, utilizing the magnetic field of the coil to actuate the switch. The minimum possible potential difference that could exist between Input 22 side to Output 26 side is determined by the isolation specification of the latching relay selected for use.

Input 22 side of Latching Relay Coupled SSR Circuit 21 can be configured in either a two terminal (see FIG. 4) or three terminal variation to accept the input signal conditions described earlier for the typical mechanical latching relay. In one embodiment of the invention, the coil impedance of Latching Relay 30 is 500 ohm when an SLD412SD magnetically latching reed relay is used, and provides the current limiting, so no additional limiting resistor is necessary when used with a seven to fourteen Vdc input signal. With a 500 ohm coil impedance, the typical input current will be approximately twenty-four ma with a twelve Vdc pulse. Per the specifications of the SLD412SD magnetically latching reed relay used in this embodiment of the invention, this input current pulse needs only to be present for a minimum of two milliseconds to provide enough magnetic coupling to change the state of the reed switch which will then hold in that state once the input current pulse is removed. In this embodiment of the invention utilizing the SLD412SD magnetically latching reed relay, a minimum of 3.5 kv possible potential difference could exist between Input 22 side to Output 26 side.

As stated earlier, Latching Relay 30 takes the place of Phototransistor 10 in the SSR circuit as shown in FIG. 1 to gate the power silicon-controlled rectifiers (“SCR”) either on, (latching relay switch closed) , or off, (latching relay switch open). The mechanical characteristics of the latching relay provide the means to hold the switch in the desired state once it has been switched. The remainder of the Output 26 side circuit is considered a common solid-state relay circuit.

FIG. 4A shows a schematic diagram of a latching relay coupled SSR circuit with a two terminal input in an embodiment of the present invention. Referring now to FIG. 4A, Latching Relay Coupled SSR Circuit 31 is identical to Latching Relay Coupled SSR Circuit 21 except that on Input 22 side, there are only two terminals instead of three terminals. A three terminal circuit as shown in FIG. 3 is more practical than the two terminal circuit shown in FIG. 4A because it is more difficult to switch polarity on the same line from a controller or computer. It is easier to have two separate lines to switch the same current, one to turn it on, and one to turn it off.

Referring now to FIG. 4B, with some types of Latching Relay 40, the SSR 38 circuit can be alternately actuated by applying the same polarity pulse to the two input terminals. That is, one pulse is used to change the state of the latching relay, and then another pulse of the same polarity is used to reverse that state. Each subsequent pulse alternates the state of the switch.

Dashed Line 34 marks the isolation between the Input 32 side and the Output 36 side of Latching Relay Coupled SSR Circuit 31. Latching Relay 40 couples the signal from the Input 32 side to the SSR 38 circuit on the Output 36 side. Latching Relay Coupled SSR Circuit 31 can be configured for either “zero-cross” or “random” turn-on style by component selection within Output 36 side.

FIG. 5 shows a schematic diagram of a latching relay coupled triac driver circuit with a three terminal input in an embodiment of the present invention. Referring now to FIG. 5, an additional embodiment of constructing a latching SSR circuit uses an identical input circuit as shown in FIGS. 3 and 4 (a latching relay), in place of the simpler Opto-Triac-Driver 20 of Opto-Triac-Driver SSR Circuit 11 of FIG. 2. This eliminates several components from the output section of the relay, but requires the latching relay switch to have an “off-state” or “open circuit” voltage rating as high as that specified for the power output SCR devices, which is typically 600 to 1200 volts. This particular manner of construction would also limit the output “turn-on” options to the “random” style only.

Dashed Line 44 marks the isolation between the Input 42 side and the Output 46 side of Latching Relay Coupled Triac Driver Circuit 41. Latching Relay 50 couples the signal from the Input 42 side to the SSR 48 circuit on the Output 46 side. Latching Relay Coupled Triac Driver Circuit 41 can only be “random” turn-on style. Latching Relay Coupled Triac Driver Circuit 41 can also be configured in a two terminal version (not shown) similar to that shown in FIG. 4.

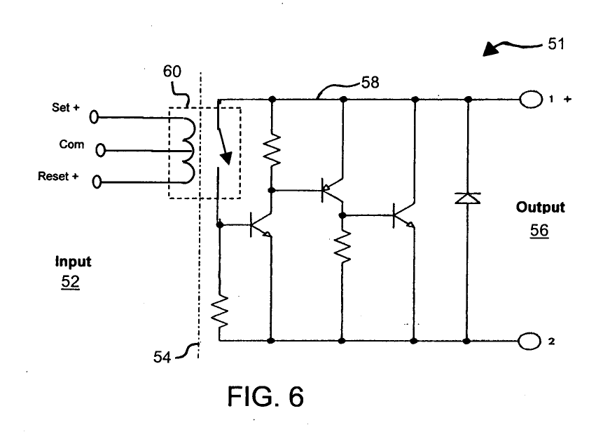

FIG. 6 shows a block diagram of a latching relay coupled DC SSR circuit with a three terminal input in an embodiment of the present invention. In addition to AC output switching latching SSRs, the latching relay technique can also be used to make a series of latching DC power switching SSRs. A representative circuit is shown in FIG. 6. As in the case of the AC output SSRs, a variety of standard output DC SSR circuitry may be utilized. Similarly, the latching relay replaces the input circuitry and opto-transistor used in a standard DC output SSR.

Referring now to FIG. 6, Dashed Line 54 marks the isolation between the Input 52 side and the Output 56 side of Latching Relay Coupled DC SSR Circuit 51. Latching Relay 60 couples the signal from the Input 52 side to the SSR 58 circuit on the Output 56 side.

One skilled in the art will recognize that by utilizing different latching relay coil variations, a wide range of input voltage can be accommodated. In the same manner, using the various SCR/Case/Base plate output power assemblies that are readily available from different manufacturers, a range of output load current ratings for the latching SSR can be produced ranging anywhere from less than 1 amp through several hundreds of amp capability.

Having described the present invention, it will be understood by those skilled in the art that many changes in construction and circuitry and widely differing embodiments and applications of the invention will suggest themselves without departing from the scope of the present invention.

What is claimed is:

1. A method for circuit switching utilizing a solid state relay, the method comprising the steps of:
(a) providing an input circuit;
(b) isolating a solid state relay output circuit from said input circuit;
(c) coupling said input circuit to said solid state relay output circuit with a latching relay; and
(d) sending an input signal momentarily through said input circuit to switch said solid state relay output circuit.

2. The method according to claim 1 wherein said latching relay is a magnetically operated latching relay.

3. The method according to claim 1 wherein step (d) further comprises the steps of:
sending said input signal momentarily through a coil of said latching relay connected to said input circuit;
generating a magnetic field in said coil due to said input signal; and
actuating a switch of said latching relay in proximity to said coil with said magnetic field, wherein said switch is connected to said solid state relay output circuit.

4. The method according to claim 3 wherein step (a) further comprises the steps of:
attaching a first input terminal to said coil; and
attaching a second input terminal to said coil, wherein said second input terminal serves as a common.

5. The method according to claim 4 wherein step (d) further comprises the steps of:
sending said input signal with a first polarity momentarily through said first input terminal to open said switch; and
sending again said input signal with a second polarity momentarily through said first input terminal to close said switch.

6. The method according to claim 4 wherein step (d) further comprises the steps of:
sending said input signal with a first polarity momentarily through said first input terminal to close said switch; and
sending again said input signal with a second polarity momentarily through said first input terminal to open said switch.

7. The method according to claim 4 wherein step (d) further comprises the steps of:
sending said input signal with a first polarity momentarily through said first input terminal to open said switch; and
sending again said input signal with said first polarity momentarily through said first input terminal to close said switch.

8. The method according to claim 4 wherein step (d) further comprises the steps of:
sending said input signal with a first polarity momentarily through said first input terminal to close said switch; and
sending again said input signal with said first polarity momentarily through said first input terminal to open said switch.

9. The method according to claim 3 wherein step (a) further comprises the steps of:
attaching a first input terminal to said coil;
attaching a second input terminal to said coil; and
attaching a third input terminal to said coil.

10. The method according to claim 9 wherein step (d) further comprises the steps of:
sending a first input signal momentarily through said first input terminal to open said switch; and
sending a second input signal momentarily through said second input terminal to close said switch;
wherein said third input terminal serves as a common to said first and second input terminals for said first and second input signals.

11. The method according to claim 9 wherein step (d) further comprises the steps of:
sending a first input signal momentarily through said first input terminal to close said switch; and
sending a second input signal momentarily through said second input terminal to open said switch;
wherein said third input terminal serves as a common to said first and second input terminals for said first and second input signals.

12. The method according to claim 1 wherein said solid state relay output circuit is a triac driver circuit.

13. The method according to claim 1 wherein said solid state relay output circuit is a direct current solid state relay circuit.

14. The method according to claim 1 wherein step (b) further comprises the steps of:
attaching a first output connection to said solid state relay output circuit;
attaching a second output connection to said solid state relay output circuit; and
connecting a load between said first and second output connections.

15. The method according to claim 14 wherein a current rating for said load ranges between less than one amperes through several hundred amperes.

16. The method according to claim 1 further comprising the step of:
configuring said solid state relay output circuit for a zero cross load switching style.

17. The method according to claim 1 further comprising the step of:
configuring said solid state relay output circuit for a random load switching style.

18. The method according to claim 1 further comprising the step of:
establishing a minimum possible potential difference between said input circuit and said solid state relay output circuit according to an isolation specification of said latching relay.

19. The method according to claim 1 further comprising the step of:
applying said input signal for a minimum amount of time according to a specification of said latching relay in order to switch said solid state relay circuit.

20. A latching solid state relay circuit comprising:
an input circuit;
a solid state relay output circuit isolated from said input circuit; and
a latching relay coupling said input circuit to said solid state relay output circuit;
wherein an input signal sent momentarily through said input circuit switches said solid state relay output circuit.

21. The latching solid state relay circuit according to claim 20 wherein said latching relay is a magnetically operated latching relay.

22. The latching solid state relay circuit according to claim 20 wherein said latching relay further comprises:
a coil connected to said input circuit; and
a switch connected to said solid state relay output circuit;
wherein said input signal sent momentarily through said coil generates a magnetic field which actuates said switch.

23. The latching solid state relay circuit according to claim 22 wherein said input circuit further comprises:
a first input terminal connected to said coil; and
a second input terminal connected to said coil, wherein said second input terminal serves as a common;
wherein momentarily applying said input signal having a first polarity to said first input terminal opens said switch, and momentarily applying again said input signal having a second polarity to said first input terminal closes said switch.

24. The latching solid state relay circuit according to claim 22 wherein said input circuit further comprises:
a first input terminal connected to said coil; and
a second input terminal connected to said coil, wherein said second input terminal serves as a common;
wherein momentarily applying said input signal having a first polarity to said first input terminal closes said switch, and momentarily applying again said input signal having a second polarity to said first input terminal opens said switch.

25. The latching solid state relay circuit according to claim 22 wherein said input circuit further comprises:
a first input terminal connected to said coil; and
a second input terminal connected to said coil, wherein said second input terminal serves as a common;
wherein momentarily applying said input signal having a first polarity to said first input terminal opens said switch, and momentarily applying again said input signal having said first polarity to said first input terminal closes said switch.

26. The latching solid state relay circuit according to claim 22 wherein said input circuit further comprises:
a first input terminal connected to said coil; and
a second input terminal connected to said coil, wherein said second input terminal serves as a common;
wherein momentarily applying said input signal having a first polarity to said first input terminal closes said switch, and momentarily applying again said input signal having said first polarity to said first input terminal opens said switch.

27. The latching solid state relay circuit according to claim 22 wherein said input circuit further comprises:
a three terminal input connected to said coil;
wherein a first input signal that is momentarily applied to a first terminal of said three terminal input will open said switch, and a second input signal that is momentarily applied to a second terminal of said three terminal input will close said switch, and further wherein a third terminal of said three terminal input serves as a common to said first and second terminals for said first and second input signals.

28. The latching solid state relay circuit according to claim 22 wherein said input circuit further comprises:
a three terminal input connected to said coil;
wherein a first input signal that is momentarily applied to a first terminal of said three terminal input will close said switch, and a second input signal that is momentarily applied to a second terminal of said three terminal input will open said switch, and further wherein a third terminal of said three terminal input serves as a common to said first and second terminals for said first and second input signals.

29. The latching solid state relay circuit according to claim 20 wherein said solid state relay output circuit is a triac driver circuit.

30. The latching solid state relay circuit according to claim 20 wherein said solid state relay output circuit is a direct current solid state relay circuit.

31. The latching solid state relay circuit according to claim 20 wherein said solid state relay output circuit further comprises:
a first output connection;
a second output connection; and
a load connected between said first and second output connections.

32. The latching solid state relay circuit according to claim 31 wherein a current rating for said load ranges between less than one ampere through several hundred amperes.

33. The latching solid state relay circuit according to claim 20 further comprising:
a zero cross load switching style.

34. The latching solid state relay circuit according to claim 20 further comprising:
a random load switching style.

35. The latching solid state relay circuit according to claim 20 wherein a minimum possible potential difference between said input circuit and said solid state relay output circuit is established according to an isolation specification of said latching relay.

36. The latching solid state relay circuit according to claim 20 wherein said input signal is present for a minimum amount of time according to a specification of said latching relay in order to switch said solid state relay circuit.
